(19) United States
(12) Patent Application Publication
(10) Pub. No.: US 2016/0032834 A1
(43) Pub. Date: Feb. 4, 2016

(54) TURBINE ENGINE, SUCH AS AN AIRPLANE TURBOFAN OR TURBOPROP ENGINE

(71) Applicant: SNECMA, Paris (FR)

(72) Inventors: Romain Plante, Moissy-Cramayel (FR); Jérémy Galiano, Savigny Sur Orge (FR); Florent Roggin, Moissy-Cramayel (FR); Gérome Sonois, Montrouge (FR)

(21) Appl. No.: 14/775,141

(22) PCT Filed: Mar. 12, 2014
(86) PCT No.: PCT/FR2014/050566

§ 371 Date: Sep. 11, 2015

(30) Foreign Application Priority Data
Mar. 15, 2013 (FR) 1352353

(51) Int. Cl. F02C 7/045

(52) U.S. Cl. CPC F02C 7/045; F05D 2260/96

(57) ABSTRACT

The invention relates to a turbine engine, such as an aircraft turbofan or a turboprop engine, including a fan casing (10) having a substantially cylindrical wall (12) surrounding the blades of the fan, and at least two annular acoustic insulation panels (18, 20) mounted radially inside said wall (12), a first panel (18) being mounted upstream of the fan, a second panel (20) being located downstream of the first panel (18) and supporting an inner layer (42) of abradable material located opposite the radially outer ends of the blades of the fan, characterised in that the two annular panels (18, 20) form a single structural unit.

The present invention relates to a turbine engine, such as an aircraft turbofan or a turboprop engine, including a fan casing of which a substantially cylindrical wall in particular surrounds the blades of the fan.

The inner surface of a fan casing conventionally comprises annular acoustic insulation panels. Said panels generally have a honeycomb annular structure, formed of adjacent cells, the inner and outer faces of which are each covered with a skin. Said panels are intended to absorb the sound waves generated by the fan of the turbine engine.

More specifically, the casing comprises an upstream panel, located upstream of the blades of the fan, a medial panel, located opposite the blades of the fan, and a downstream panel, located downstream of the blades of the fan. The medial panel conventionally comprises a layer of abradable material against which the radially outer ends of the blades are intended to rub during operation.

In order to improve the acoustic treatment upstream of the fan, the cells of the honeycomb structure of the upstream panel have a relatively substantial section and the inner skin of said panel is generally multiperforated. The medial panel generally has cells with smaller sections than the upstream panel, such as to increase the strength thereof to mechanical stresses.

In general, all of the panels comprise more dense areas at the upstream and downstream edges thereof. This increase in density is achieved by filling the corresponding cells with a foam which, by polymerising, produces a high mechanical resistance at the related edges of the panels.

According to a first embodiment of the prior art, described in particular in patent applications FR 12/60493 and FR 12/60495 not yet published by the Applicant, each panel is attached to the annular wall by means of attachment means located at the upstream and downstream portions of each panel.

Such an embodiment requires the use of numerous attachment means, which increases the mass of the unit.

According to a second embodiment of the prior art, the upstream and medial panels are attached to the annular wall by means of a thermosetting adhesive film. The heating of the adhesive film may be achieved, for example, in an autoclave.

Alternatively, the adhesive may be a thermosetting adhesive suitable for attaching the panel on said wall when the adhesive is heated to a first temperature and suitable for releasing the panel when the adhesive is heated to a second temperature. Such an alternative embodiment enables easy assembly and disassembly of panels.

In these cases however, the number of panels to be mounted inside the wall of the casing remains large, which is relatively tedious.

Moreover, for each of the above-mentioned embodiments, the large number of panels combined with the fact that each panel comprises dense areas at the upstream and downstream edges thereof is also detrimental in terms of mass.

The invention more particularly aims at providing a simple, efficient and cost-effective solution to this problem.

For this purpose, it proposes a turbine engine, such as an aircraft turbofan or a turboprop engine, including a fan casing having a substantially cylindrical wall surrounding the blades of the fan, and at least two annular acoustic insulation panels mounted radially inside said wall, a first panel being mounted upstream of the fan, a second panel being located downstream of the first panel and supporting an inner layer of abradable material located opposite the radially outer ends of the blades of the fan, characterised in that the two annular panels form a single structural unit.

In this manner, the number of structurally separate panels is reduced, which facilitates the mounting and the attachment of the unit. Furthermore, given this reduced number of individual panels, it is also possible to reduce the number of attachment means and the number of dense areas, so as to obtain a significant gain in terms of mass.

According to one embodiment of the invention, the downstream edge of the first panel is attached to the upstream edge of the second panel, for example, by gluing.

The two panels thus form a single structural unit, easier to handle and to attach inside the wall of the casing.

Adhesive bonding is easy to implement and does not require the presence of dense areas at the downstream edge of the first panel or at the upstream edge of the second panel.

Advantageously, each panel comprises a honeycomb annular structure formed of adjacent cells, the inner and outer surfaces of said annular structure being respectively covered by an inner skin and an outer skin.

In this case, the cells of the first panel have a larger section than the cells of the second panel.

This makes it possible to improve the acoustic treatment upstream of the fan, while guaranteeing a high mechanical resistance at the portion supporting the abradable layer, said portion being subjected to high thermal and/or mechanical stresses.

According to one characteristic of the invention, at least one portion of the inner skin of the first panel and/or of the second panel comprises perforations.

Such perforations make it possible to further improve the acoustic insulation.

Moreover, the turbine engine may comprise upstream attachment means, located at the upstream portion of the first panel, downstream attachment means, located at the downstream portion of the second panel, and medial attachment means, located at the junction area between the first and second panels, said attachment means enabling the attachment of said panels to the wall of the casing.

According to another embodiment, the first panel and the second panel form a single panel.

In this case, said single panel may be attached to the wall of the casing using upstream attachment means, located at the upstream portion of the panel, and downstream attachment means, located at the downstream portion of the panel.

Indeed, the fact that the first and second panels are formed from a single panel increases the mechanical resistance of the latter. It is thus possible to reduce the number of attachment means used and, consequently, the mass of the turbine engine.

The panels may also be attached to the wall of the casing by means of an adhesive film.

In this case, the adhesive may be a thermosetting adhesive suitable for attaching the panel on said wall when the adhesive is at a first temperature and suitable for releasing the panel when the adhesive is heated to a second temperature.

The invention will be better understood and other details, features and advantages of the invention will appear upon reading the following description given by way of a non-restrictive example while referring to the appended drawings wherein:

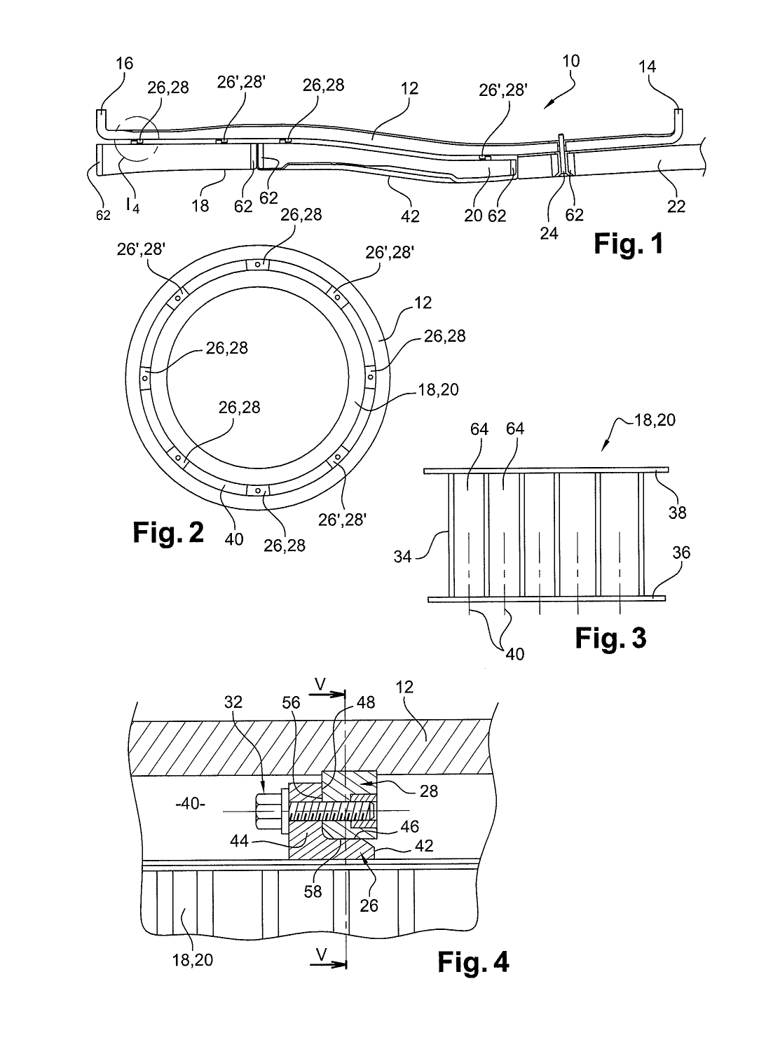

FIG. 1 is a schematic half-view in axial section of a fan casing of a turbine engine according to a first embodiment of the prior art;

FIG. 2 is a front view from the upstream of the casing in FIG. 1;

FIG. 3 is a partial schematic half-view in axial section of an acoustic insulation panel of the fan casing in FIG. 1;

FIG. 4 is a larger-scale view of the detail I₄ in FIG. 1, and shows means for attaching an acoustic insulation panel;

FIG. 5 is a schematic sectional view along the line V-V in FIG. 4;

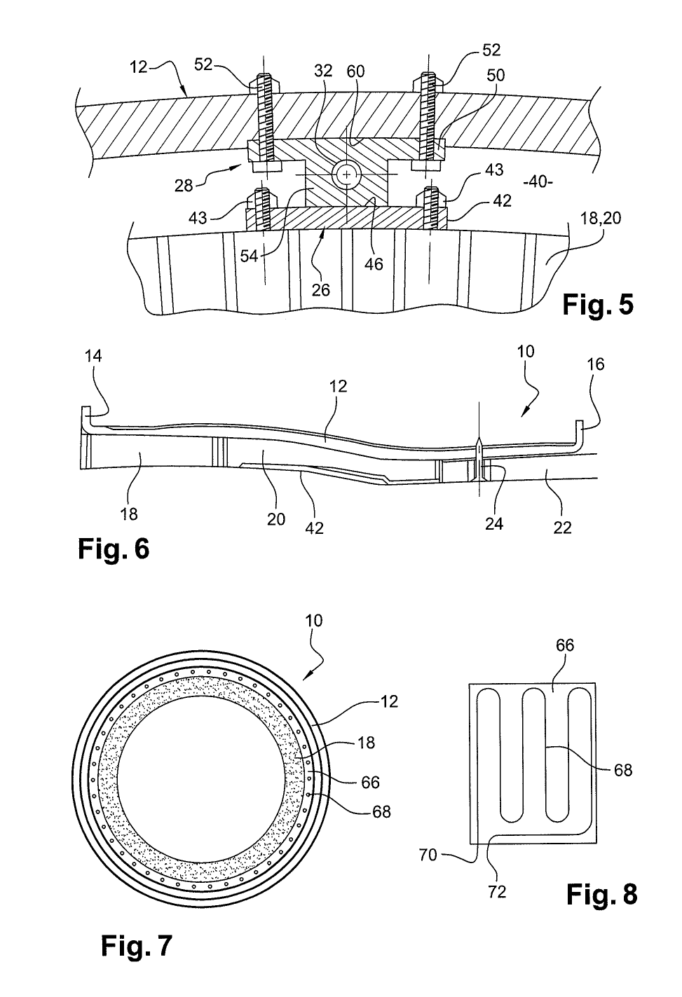

FIG. 6 is a schematic half-view in axial section of a fan casing of a turbine engine according to a first embodiment not belonging to the invention;

FIG. 7 is a schematic front view from the upstream of the casing in FIG. 6.

FIG. 8 is a schematic view of a portion of the adhesive film of the casing in FIGS. 6 and 7;

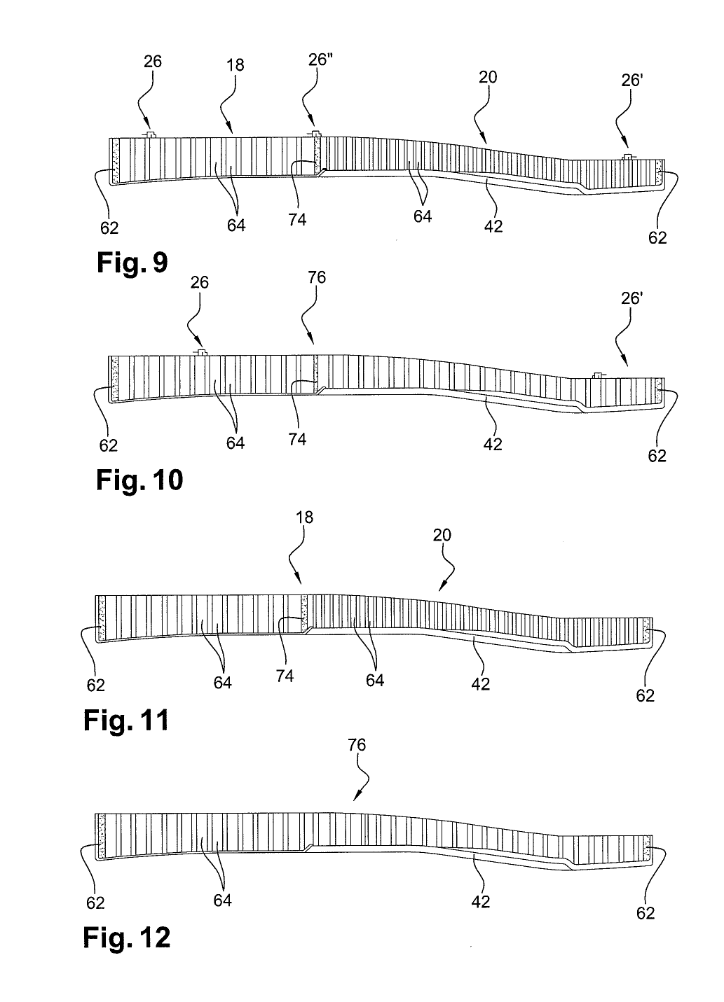

FIG. 9 a perspective view of a first and second panel, glued to one another such as to form a single structural unit attached to the wall of a fan casing by means of attachment means, in accordance with a first embodiment of the invention,

FIG. 10 is a view corresponding to FIG. 9, illustrating a second embodiment of the invention in which the first and second panels are formed from a single panel,

FIGS. 11 and 12 are views corresponding respectively to FIGS. 9 and 10, in which the panels are attached to the wall of the casing by adhesion, in accordance with two alternative embodiments of the invention.

FIGS. 1 to 5 illustrate the first embodiment of the prior art, known from patent application FR 12/60495 in the name of the Applicant. In particular, FIG. 1 shows a fan casing 10 of a turbine engine, such as an aircraft turbofan or a turboprop engine, said casing forming part of a nacelle that surrounds the motor of the turbine engine and inside of which rotates a fan that generates a secondary air flow that flows between the nacelle and the motor and forms a portion of the thrust produced by the turbine engine.

The casing 10 includes a substantially cylindrical wall 12 that comprises at the longitudinal ends thereof annular attachment flanges 14, 16. The downstream flange 14 is attached by means of the screw and nut type to a flange (not shown) of an intermediate casing and the upstream flange 16 is attached by means of the screw and nut type to a flange (not shown) of an air intake machine in the nacelle.

The casing includes annular acoustic insulation panels 18, 20, 22 that cover the inner cylindrical surface of the wall 12 and that are attached to said wall.

In the example shown, the wall 12 has three annular panels 18, 20, 22, two one-piece panels 18, 20, respectively upstream and medial, and one downstream panel 22 that is sectorised.

The downstream panel 22 includes panel sectors that are arranged circumferentially end to end and that are attached on the wall 12 by screws 24 passing radially through the sectors and engaged in holes of the wall 12.

The annular panels 18, 20 are one-piece (i.e. not sectorised) and are attached on the wall 12 by technology that enables the disassembly of panels, in particular under the wing of an aircraft during a maintenance operation.

The panels 18, 20 comprise more dense areas 62 at the upstream and downstream edges thereof. This increase in density is achieved by filling the corresponding cells with a foam which, by polymerising, produces a high mechanical resistance at the related edges of the panels.

In the example shown in FIGS. 1 to 5, the panels 18, 20 are mounted inside the wall 12 and attached to said wall by means of the screw and nut type, each panel comprising axial and radial bearing lugs 26 on the lugs 28 of the wall 12, said lugs comprising holes for passage of the means 32 of the screw and nut type.

FIG. 3 shows an example of embodiment of a panel 18, 20 comprising a honeycomb annular structure 34 the inner and outer faces of which are each covered with a stratified skin 36, 38, the inner skin 36 comprising multiperforations 40. Moreover, the panel may include a layer of abradable material, in particular in the area of the panel surrounding the fan blades, as is the case of the panel 20 that includes under the inner skin 36 thereof an inner layer 42 made of abradable material (FIG. 1).

In order to improve further the acoustic treatment upstream of the fan, the cells 64 of the honeycomb structure of the panel 18 have a relatively substantial section. The panel 20 generally has cells with smaller sections than the panel 18, such as to increase the resistance thereof to mechanical stresses generated in particular by the rubbing of the radially outer ends of the blades against the layer of abradable material 42.

As shown in FIG. 2, each panel 18, 20 is formed from a single part without interruption, the lugs 26 being attached on the outer skin 38 of the panel and being located in an annular space 40 extending between the panel 18, 20 and the wall 12. Said annular space 40 may have a thickness or radial dimension in the order of 10 mm.

Each panel 18, 20 is equipped with two annular rows of lugs, an upstream row of lugs 26, 28 and a downstream row of lugs 26′, 28′. The lugs of each row are evenly distributed about the longitudinal axis of the casing and are diametrically opposite in pairs. The lugs 26, 28 of the upstream row are moreover angularly offset from the lugs 26′, 28′ of the downstream row, in relation to the longitudinal axis of the casing (FIG. 2). Each row includes, for example, twelve lugs 26, 26′, 28, 28′.

The lugs 26 supported by the panel 18, 20 have a substantially L-shape and each include a longitudinal portion 42 applied on the outer skin 38 of the panel and attached to said skin by screws 43 engaging with crimped nuts of the self-locking type (FIG. 5). Said longitudinal portion 42 has a cylinder-shaped portion and closely fits the outer shape of the panel.

The portion 42 of the lug 26 is connected at one of the longitudinal ends thereof to a substantially radial portion 44 that extends outwardly and that includes a through hole for passage of the screw 32.

The portion 42 of the lug 26 includes a cylindrical radially outer bearing surface 46 and the radial portion 44 includes a radial bearing surface 48.

As shown in FIG. 5, the portion 44 of the lug 26 has a circumferential dimension less than that of the portion 42 thereof.

The lugs 28 supported by the wall 12 each include a substantially flat radially outer portion 50 applied on the radially inner surface of the wall 12 and attached thereto by screws 52 engaging with crimped nuts of the self-locking type, and a portion 54 extending radially inwardly and that includes a through hole aligned with the hole of the lug 26 for the passage of the screw 32 for attaching said lugs.

Said portion 54 includes a radial bearing surface 56 on the radial surface 48 of the lug 26 and a flat or substantially cylindrical bearing surface 58 on the cylindrical surface 46 of the lug 26.

As shown in FIG. 5, the portion 54 of the lug 28 has a circumferential dimension less than that of the portion 50 thereof. Furthermore, the portion 50 of the lug 28 is partly inserted into a recess 60 of complementary shape of the wall 12.

The panels 18, 20 previously described may be mounted inside the wall 12 of the casing in the following manner.

Each panel 18, 20 is arranged upstream of the wall 12, coaxially thereto, and is positioned angularly about the longitudinal axis of the casing such that the lugs 26, 26′ thereof are aligned axially with those 28, 28′ of the casing. The panel is then displaced in axial translation in the downstream direction until it is lodged inside the wall 12 and that the lugs 26, 26′ thereof are axially bearing against those 28, 28′ of the casing.

A tool such as a ratcheting wrench equipped with an extension is then used to screw the screws 32 into the lugs in order to secure the panel to the casing. This tool is axially inserted from the upstream into the annular space 40 extending between the panel and the wall.

As previously indicated, such an embodiment requires the use of numerous attachment means 26, 28, 26′,28′, 32, which increases the mass of the unit. Furthermore, the presence of dense areas 62 at the panels 18, 20 is also detrimental in terms of mass. Finally, the number of panels to be mounted then to be attached inside the wall 12 of the casing is large, which is long and tedious.

FIGS. 6 to 8 illustrate an embodiment not belonging to the invention.

Said embodiment differs from that previously described in that the panels 18, 20 (sectorised or single-piece) are attached by an adhesive film 66 to the inner surface of the wall 12. The adhesive film 66 is heat sensitive. Indeed, it is suitable for attaching the panels 18, 20 on said wall 12 when the adhesive is at a first temperature and suitable for releasing the panels 18, 20 when the adhesive is heated to a second temperature. Such an adhesive film 66 therefore enables the easy disassembly and assembly of panels 18, 20.

Said film 66 comprises a conductive wire 68, for example, carbon-based, the ends 70, 72 of which are connected to the terminals of a power supply. The wire 68 is embedded in the polymer matrix formed by the adhesive film 66. The passage of an electric current in the wire 68 causes the heating thereof. As shown in FIG. 3, the wire 68 may be arranged in coil and extend over the entire surface of the film 66.

During normal operation, the adhesive film 66 is subjected to low temperatures. In this case, the film 66 provides the function thereof of attaching the panels 18, 20 on the wall 12.

Thus, when one of the panels 18, 20 is damaged and must be replaced, it is sufficient to heat the film 66 so as to soften the adhesive and enable the removal of the corresponding panel 18, 20.

The latter is then replaced by a sound panel. In this case, the adhesive film is reheated to facilitate the adhesion of the sound panel on the wall 12.

Such an embodiment thus facilitates the repair of a fan casing 10, since it enables the quick and easy disassembly of panels 18, 20, in particular in the event of maintenance under the wing of an aircraft (i.e. without removal of the engine). Such an embodiment also applies to the case of mounting of the panels 18, 20 in the factory.

As previously indicated, the presence of dense areas 62 at the panels 18, 20 is detrimental in terms of mass. Finally, the number of panels to be mounted then to be attached inside the wall of the casing is large, which is relatively tedious.

In order to remedy the above-mentioned drawbacks, the invention proposes a turbine engine in which the two annular panels 18, 20 form a single structural unit.

For this purpose, in a first embodiment illustrated in FIG. 9, the invention proposes to glue the downstream edge of the panel 18 to the upstream edge of panel 20. The corresponding adhesive film is referenced 74.

As previously, the cells 64 of the panel 18 have a larger section than the cells 64 of the second panel 20.

In said embodiment, the edges of the panels 18, 20 intended to be glued to one another do not necessarily comprise dense areas 62. Only the upstream edge of the panel 18 and the downstream edge of the panel 20 therefore comprise a dense area 62.

Also in said embodiment, the unit formed by the panels 18, 20 comprises upstream attachment means 26, located at the upstream portion of the 18, downstream attachment means 26′, located at the downstream portion of the 20, and medial attachment means 26″, located at the junction area 74 between the panels 18, 20, said attachment means 26, 26′, 26″ enabling the attachment of said panels 18, 20 to the wall 12 of the casing.

Said attachment means 26, 26′, 26″ are, for example, similar to those described with reference to FIGS. 1 to 5.

FIG. 10 illustrates a second embodiment of the invention, in which a single panel 76 provides the function of the panel 18 and the function of the panel 20. Said panel 76 has dimensions similar to those of the unit formed by the panels 18 and 20 in FIG. 9. It supports, as previously, a layer of abradable material 42 and comprises dense areas 62 at the upstream and downstream edges thereof. The panel 76 has a structure similar to that of the panels 18, 20, the cells 64 having, however, all the same section. Of course, it is possible to vary the section of the cells according to the position thereof in the panel 76, if the mechanical stresses in play so require.

The panel 76 comprises upstream attachment means 26, located at the upstream portion of the panel 76, and downstream attachment means 26′, located at the downstream portion of the panel 76.

FIG. 11 illustrates a third embodiment similar to that of FIG. 9, in which the panels 18 and 20 are attached to the wall 12 of the casing using an adhesive film 66 (not shown in FIG. 11) similar to that described with reference to FIGS. 6 to 8.

Similarly, FIG. 12 illustrates a third embodiment similar to that of FIG. 10, in which the panel 76 is attached on the wall 12 of the casing using an adhesive film 66 (not shown in FIG. 12) similar to that described with reference to FIGS. 6 to 8.

In each of said embodiments, the mass of the unit is reduced in comparison to the prior art, whether by the reduced number of dense areas 62 or by the reduced number of attachment means. Furthermore, the fact of having a single structural unit, providing the same functions as the panels 18 and 20 of the prior art, makes it possible to facilitate the assembly and disassembly thereof.

1. A turbine engine, such as an aircraft turbofan or a turboprop engine, including a fan casing comprising a substantially cylindrical wall surrounding the blades of the fan, and at least two annular acoustic insulation panels mounted radially inside said wall, a first panel being mounted upstream of the fan, a second panel being located downstream of the first panel and supporting an inner layer of abradable material located opposite the radially outer ends of the blades of the fan, characterised in that the downstream edge of the first panel is attached to the upstream edge of the second panel, for example, by gluing.

2. A turbine engine according to claim 1, characterised in that each panel comprises a honeycomb annular structure formed of adjacent cells, the inner and outer surfaces of said annular structure being respectively covered by an inner skin and an outer skin.

3. A turbine engine according to claim 2, characterised in that the cells of the first panel have a larger section than the cells of the second panel.

4. A turbine engine according to claim 2, characterised in that at least one portion of the inner skin of the first panel and/or of the second panel comprises perforations.

5. A turbine engine according to claim 1, characterised in that it comprises upstream attachment means, located at the upstream portion of the first panel, downstream attachment means, located at the downstream portion of the second panel, and medial attachment means, located at the junction area between the first and second panels, said attachment means enabling the attachment of said panels to the wall of the casing.

6. A turbine engine according to claim 1, characterised in that the panels are attached to the wall of the casing by means of an adhesive film.

7. A turbine engine according to claim 6, characterised in that the adhesive is a heat sensitive adhesive suitable for attaching the panel on said wall when the adhesive is at a first temperature and suitable for releasing the panel when the adhesive is heated to a second temperature.
